(19) United States
(12) Patent Application Publication
(10) Pub. No.: US 2026/0217369 A1
(43) Pub. Date: Jul. 30, 2026

(54) AMMUNITION STORAGE ELEMENT

(71) Applicant: Tusas- Turk Havacilik Ve Uzay Sanayii Anonim Sirketi, Kahramankazan, Ankara (TR)

(72) Inventors: Engin TASKIRAN, Kahramankazan, Ankara (TR); Gorkem DEMIR, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/142,258

(22) PCT Filed: Nov. 13, 2023
(86) PCT No.: PCT/TR2023/051314

§ 371 Date: Jun. 23, 2025

(30) Foreign Application Priority Data
Dec. 21, 2022 (TR) 2022/019965

(51) Int. Cl. B64D 7/00

(52) U.S. Cl. CPC B64D 7/00

(57) ABSTRACT

The present invention relates to at least one body (2) located on an air vehicle (A) for placing an ammunition therein; an aerodynamic surface(S) forming an outer wall of the body (2); at least one leading edge cover (3) located on the body (2) so as to come into primary contact with the air flow (F) to which the body (2) is exposed when the air vehicle (A) moves; at least one trailing edge cover (4) located on a surface where the air flow (F) leaves the body (2).

This invention relates to an ammunition storage element developed to reduce negative aerodynamic effects of external loads on an air vehicle.

Payloads such as ammunition and/or fuel tanks are positioned at load stations on air vehicles. Depending on the type thereof, payloads are positioned under the wing or at load stations on the air vehicle fuselage. Positions of the payloads on the air vehicle and the external aerodynamic surface forms affect the flow regimes on the aerodynamic surfaces of the air vehicle. Payloads placed under the wing undergo problems that negatively affect longitudinal stability due to the aerodynamic flow effects occurring in the tail area of the air vehicle. Storage elements of different geometries are used to reduce negative aerodynamic effects of payloads, such as ammunition, under the wing on the air vehicle.

US20200255136, which is included in the known-state of the art, discloses a launcher structure with a flat rear wall, which is cylindrical shape and an exposed at the rear part. said launcher contains multiple rockets, and is positioned under the wing of the air vehicle. U.S. Pat. No. 5,058,481, which is included in the known-state of the art, discloses a rocket launcher made of composite materials and produced in accordance with the air flow in order to reduce aerodynamic effects reflected on the body of the air vehicle. The patent document describes production of the covers at the exit ports on the rocket launcher and the launcher body in an angular geometry to provide aerodynamic advantage.

Thanks to the ammunition storage element according to the present invention, negative aerodynamic effects caused by a payload on an air vehicle are reduced.

Another object of the invention is to improve longitudinal stability of the air vehicle by ammunition storage elements positioned at the air vehicle.

The ammunition storage element realized to achieve the object of the invention, which is illustrated in the first claim and other claims dependent thereon, comprises at least one body for placing ammunition or similar payloads therein; an aerodynamic surface which is formed by the combination of multiple diagonal cross-sections to almost completely surround an outer wall of the body, and on which the air flow moves along the body during a flight of the air vehicle; at least one leading edge cover positioned on the body to meet the air flow to which the body is exposed when the air vehicle moves; at least one trailing edge cover positioned on a surface where the air flow traveling along the body leaves the body.

The ammunition storage element according to the invention comprises the trailing edge cover, which is in the form of a polygonal dome for the continuity of the aerodynamic surfaces with diagonal cross-section on the body, thus reducing the drag on the air vehicle caused by air flow irregularities as the air flow leaves the body.

In an embodiment of the invention, the ammunition storage element comprises a body with multiple diagonal cross-sections, which is fixed along the direction it extends. Therefore, air flow is moved over the diagonal cross-sections on the aerodynamic surface throughout the body.

In an embodiment of the invention, the ammunition storage element comprises a trailing edge surface consisting of multiple diagonal cross-sections and forming an outer wall of the trailing edge cover, almost completely surrounding the trailing edge cover; the trailing edge cover in convex form, which is removably mounted on the rear of the body so that almost each diagonal cross-section on the trailing edge surface is mutually aligned with almost each diagonal cross-section on the aerodynamic surface. Thanks to the mutual alignment of the diagonal cross-sections on the aerodynamic surface and the diagonal cross-sections on the trailing edge surface, the air flow moving over the body is enabled to move along the body in a prescribed manner, without creating a vortex.

In an embodiment of the invention, the ammunition storage element comprises a body reference axis which is parallel to the roll axis of the air vehicle and passes through the geometric center of the body along its direction; the trailing edge cover, wherein the trailing edge surfaces forming the outer wall thereof and consisting of multiple diagonal cross-sections are in a curved form, so as to extend towards the body reference axis and approach the body reference axis. Thanks to the curved trailing edge surfaces on the trailing edge cover, the vortices to be created by the air flow moving from the diagonal aerodynamic surfaces to the trailing edge surfaces before leaving the body, can be prevented.

In an embodiment of the invention, the ammunition storage element comprises at least one ridge in a curved form, in which almost each trailing edge surface with a diagonal cross-section extends towards the body reference axis to join each other, and from which the air flow leaves the trailing edge cover. The trailing edge surfaces join together on the ridge, each at a different angle from the other, creating a polygonal dome geometry on the trailing edge cover. The ridge where the air flow leaves the trailing edge cover is in the form of a curved arc. The trailing edge surfaces with diagonal cross-section on the ridge are asymmetrical with respect to each other, while the trailing edge surfaces under the ridge are placed on the trailing edge cover so as to be asymmetrical with respect to each other. The trailing edge surfaces under the ridge and the trailing edge surfaces on the ridge are located on the trailing edge cover, mirror symmetrically to each other with respect to the body reference axis, so as to form a polygonal dome form, wherein said surfaces on and under the ridge are located in an irregular cross-sectional form, symmetrically with respect to the body reference axis. Therefore, the drag effect created by the ammunition storage element on the air vehicle is reduced by preventing vortices caused by the air flow disturbances in the area where the air flow leaves the body.

In an embodiment of the invention, the ammunition storage element comprises at least one elevator located on the air vehicle for allowing the air vehicle to make pitch movements; the trailing edge cover located behind the body, so as to be in alignment with the wing trailing edge almost opposite thereto, such that air flow leaving the ammunition storage element does not create irregularities for the air flow on the elevator located almost in alignment with the ammunition storage element. Thanks to the trailing edge cover in the form of a polygonal dome, longitudinal stability of the air vehicle is increased by creating a more regular air flow on the elevator.

In an embodiment of the invention, the ammunition storage element comprises the body, which is a prismatic dodecagon with the aerodynamic surface in the form of a diagonal cross-section. A dodecagonal geometry is formed with trailing edge surfaces in the form of diagonal cross-sections on the trailing edge cover, which is mounted to ensure continuity of air flow on the body after the aerodynamic surface.

In an embodiment of the invention, the ammunition storage element comprises the air vehicle, which is aircraft and/or a helicopter.

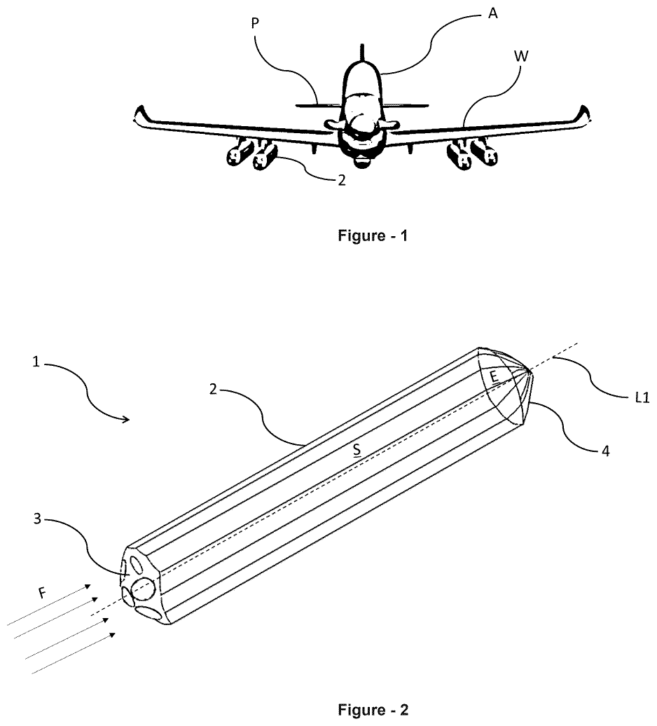

The ammunition storage element realized to achieve the object of the present invention is illustrated in the attached drawings, in which:
FIG. 1 is a front view of the air vehicle and body.

FIG. 2 is a perspective view of the body.

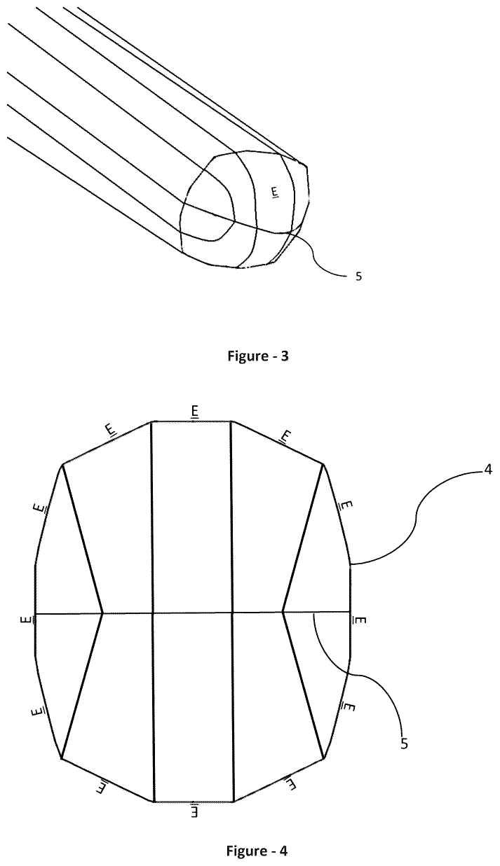

FIG. 3 is a perspective view of the trailing edge cover and ridge.

FIG. 4 is a front view of the trailing edge surface and ridge.

All the parts illustrated in figures are individually assigned a reference numeral and the corresponding terms of these numbers are listed below:
1. Ammunition Storage Element
2. Body
3. Leading Edge Cover
4. Trailing Edge Cover
5. Ridge
(A) Air Vehicle
(F) Air Flow
(S) Aerodynamic Surface
(E) Trailing Edge Surface
(W) Wing
(P) Elevator
(L1) Body Reference Axis

The ammunition storage element (1) comprises at least one body (2) located on an air vehicle (A) for placing an ammunition therein; an aerodynamic surface(S) forming an outer wall of the body (2); at least one leading edge cover (3) located on the body (2) so as to come into primary contact with the air flow (F) to which the body (2) is exposed when the air vehicle (A) moves; at least one trailing edge cover (4) located on a surface where the air flow (F) leaves the body (2).

The ammunition storage element (1) according to the invention comprises the trailing edge cover (4) in the form of a polygonal dome to enable continuity of the aerodynamic surfaces (S) on the body (2), thus allowing the drag on the air vehicle to be reduced.

The ammunition to be released by the air vehicle (A) is placed inside the body (2) and positioned on the air vehicle. It consists of an aerodynamic surface(S) with a diagonal cross-section, on which air flow (F) occurs on the outer wall of the body (2). Therefore, the drag effect caused by irregularities in the air flow (F) on the body (2) is reduced. When the air vehicle (A) moves, the air flow (F) first moves over the leading edge cover (3) and then over the body (2), after which it moves on the trailing side cover (4) to leave the body (2). The continuity of the aerodynamic surface (S) must be enabled in order to move the air flow (F) on the body (2) without creating a drag and flow irregularity. In order to enable the continuity of the aerodynamic surface(S), the trailing edge cover (4), e.g. a polygonal dome where the air flow (F) leaves the body (2), is mounted on the body (2). Thanks to the polygonal dome form, the drag on the air vehicle (A) due to air flow (F) irregularities caused by the air flow (F) leaving the body (2), is reduced (FIG. 1, FIG. 2).

In an embodiment of the invention, the ammunition storage element (1) comprises the body (2) with a diagonal cross-section at full-length. The aerodynamic surface (S) extending longitudinally on the body (2) has a fixed diagonal cross-section. In this way, air flow (F) irregularities are prevented by creating a fixed path for air flow (F) on the aerodynamic surface (S). Therefore, air flow (F) is moved over the diagonal cross-sections located on the aerodynamic surface (S) along the body (2).

In an embodiment of the invention, the ammunition storage element (1) comprises a trailing edge surface (E) on the trailing edge cover (4); the trailing edge cover (4) removably mounted on the back of the body (2) such that the trailing edge surface (E) is aligned with the aerodynamic surface (S) to allow the air flow (F) to move on the body (2) without being disturbed. Therefore, thanks to the mutual alignment of the diagonal cross-sections on the aerodynamic surface (S) and the diagonal sections on the trailing edge surface (E), the air flow (F) moving on the body (2) is enabled to move along the body (2) in a prescribed manner, without creating a vortex.

In an embodiment of the invention, the ammunition storage element (1) comprises a body reference axis (L1) parallel to a roll axis of the air vehicle (A) and passing through the geometric center of the body (2) along the direction it extends; the trailing edge cover (4) on which almost each trailing edge surface (E) extends towards the body reference axis (L1), thus enabling the continuity of the aerodynamic surfaces (S) and preventing air flow (F) disturbances on the air vehicle (A). Thanks to the trailing edge surfaces (E) in a curved form on the trailing edge cover (4), the air flow (F) moving from the aerodynamic surfaces (S) with diagonal cross-section to the trailing edge surfaces (E) leaves the trailing edge cover (4) and the body (2) without creating a vortex.

In an embodiment of the invention, the ammunition storage element (1) comprises at least one ridge (5) located in a curved form on the trailing edge cover (4), wherein almost each trailing edge surface (E) extends towards the body reference axis (L1) so as to join together at the ridge (5), thereby preventing irregularities in the air flow (F) when the air flow (F) leaves the rear cover (4). In this way, the trailing edge surfaces (E) under the ridge (5) and the trailing edge surfaces (E) above the ridge (5) are located on the trailing edge cover (4) in irregular cross-sectional form relative to each other, symmetrically with respect to the body reference axis (L1). Thus, the drag effect created by the ammunition storage element (1) on the air vehicle is reduced by preventing the vortices caused by the air flow (F) disturbances at the ridge (5) region where the air flow (F) leaves the body (2) (FIG. 3, FIG. 4).

In an embodiment of the invention, the ammunition storage element (1) comprises at least one elevator (P) on the air vehicle (A); the trailing edge cover (4) positioned on the body (2) by the manufacturer, in alignment with the trailing edge of the wing (W) and almost in alignment with the elevator (P), thereby preventing irregularities caused by the air flow (F) on the elevator (P), and increasing the longitudinal stability of the air vehicle (A). The trailing edge cover (4) in the form of a polygonal dome is located on the body (2), in alignment with the wing (W) on a vertical axis, and almost facing the elevator (P). In this way, a more regular air flow (F) is created on the elevator (P) by the trailing edge cover (4) in the form of a polygonal dome, so that the longitudinal stability of the air vehicle (A) is increased.

In an embodiment of the invention, the ammunition storage element (1) comprises the body (2) and the trailing edge cover (4) that have a dodecagonal prismatic cross-section. Therefore, continuity of the air flow (F) is provided on the aerodynamic surface(S) and the trailing edge surface (E).

In an embodiment of the invention, the ammunition storage element (1) comprises the body (2) on the air vehicle (A), which is an aircraft and/or a helicopter.

1. An ammunition storage element (1) comprising at least one body (2) located on an air vehicle (A) for placing an ammunition therein; an aerodynamic surface (S) forming an outer wall of the body (2); at least one leading edge cover (3) located on the body (2) so as to come into primary contact with the air flow (F) to which the body (2) is exposed when the air vehicle (A) moves; at least one trailing edge cover (4) located on a surface where the air flow (F) leaves the body (2), wherein the trailing edge cover (4) in the form of a polygonal dome to enable continuity of the aerodynamic surfaces (S) on the body (2), thus allowing the drag on the air vehicle to be reduced, the body (2) with a diagonal cross section at full length along the direction it extends.

2. (canceled)

3. An ammunition storage element (1) according to claim 1, wherein a trailing edge surface (E) on the trailing edge cover (4); the trailing edge cover (4) removably mounted on the back of the body (2) such that the trailing edge surface (E) is aligned with the aerodynamic surface(S) to allow the air flow (F) to move on the body (2) without being disturbed.

4. An ammunition storage element (1) according to claim 3, wherein a body reference axis (L1) parallel to a roll axis of the air vehicle (A) and passing through the geometric center of the body (2) along the direction it extends; the trailing edge cover (4) on which almost each trailing edge surface (E) extends towards the body reference axis (L1), thus enabling the continuity of the aerodynamic surfaces (S) and preventing air flow (F) disturbances on the air vehicle (A).

5. An ammunition storage element (1) according to claim 3, wherein at least one ridge (5) located in a curved form on the trailing edge cover (4), wherein almost each trailing edge surface (E) extends towards the body reference axis (L1) so as to join together at the ridge (5), thereby preventing irregularities in the air flow (F) when the air flow (F) leaves the rear cover (4).

6. An ammunition storage element (1) according to claim 3, wherein at least one elevator (P) on the air vehicle (A); the trailing edge cover (4) positioned on the body (2) by the manufacturer, in alignment with the trailing edge of the wing (W), and almost in alignment with the elevator (P) and the trailing edge cover (4) in the form of a polygonal dome is located on the body (2), in alignment with the wing (W) on a vertical axis, thereby preventing irregularities caused by the air flow (F) on the elevator (P), and increasing the longitudinal stability of the air vehicle (A).

7. An ammunition storage element (1) according to claim 1, wherein the body (2) and the trailing edge cover (4) that have a dodecagonal prismatic cross-section.

8. An ammunition storage element (1) according to claim 1, wherein the body (2) on the air vehicle (A), which is an aircraft and/or a helicopter.
